(19) United States
(12) Patent Application Publication
(10) Pub. No.: US 2026/0237569 A1
(43) Pub. Date: Aug. 13, 2026

(54) ELECTROLYTIC CAPACITOR AND METHOD FOR MANUFACTURING SAME

(71) Applicant: Panasonic Intellectual Property Management Co., Ltd., Osaka (JP)

(72) Inventors: KENTA CHASHIRO, Osaka (JP); YUICHIRO TSUBAKI, Kyoto (JP)

(21) Appl. No.: 19/154,005

(22) PCT Filed: Feb. 19, 2024
(86) PCT No.: PCT/JP2024/005848

§ 371 Date: Aug. 6, 2025

(30) Foreign Application Priority Data
Feb. 28, 2023 (JP) 2023-030127

(51) Int. Cl. H01G 9/15; H01G 9/00; H01G 9/025; H01G 9/035; H01G 9/07

(52) U.S. Cl. CPC H01G 9/15; H01G 9/0029; H01G 9/025; H01G 9/035; H01G 9/07

(57) ABSTRACT

An electrolytic capacitor includes a capacitor element and a liquid component. The liquid component contains a solvent, an inorganic acid, and an organic oxy compound. The amount of the organic oxy compound per mol of the inorganic acid is more than 0.5 mol. The organic oxy compound includes at least one molecular structure selected from the group consisting of: (A) two first carbon atoms adjacent to each other, (B) two second carbon atoms adjacent to each other, (C) a first carbon atom and a second carbon atom adjacent to each other, and (D) one or more second carbon atoms. The first carbon atom is a carbon atom to which only one group selected from OH group or COOH group is bonded, and the second carbon atom is a carbon atom to which two or more groups selected from OH group or COOH group are bonded.

### TECHNICAL FIELD

The present disclosure relates to an electrolytic capacitor and a method for manufacturing the electrolytic capacitor.

### BACKGROUND

PTL 1 proposes “an electrolytic capacitor including a capacitor element in which an anode electrode foil on which a dielectric oxide film is formed and a cathode electrode foil are wound with a separator interposed therebetween, the electrolytic capacitor including a conductive polymer layer formed on the dielectric oxide film, and an electrolytic solution impregnated in the capacitor element, where the electrolytic solution contains a first solvent selected from γ-valerolactone, γ-butyrolactone, δ-valerolactone, and α-methyl-γ-butyrolactone, a second solvent selected from polyalkylene glycols having number average molecular weights from 100 to 250 inclusive and derivatives thereof, and a third solvent selected from polyalkylene glycols having number average molecular weights ranging from 500 to 2000, inclusive, and derivatives thereof”. In examples, triethylamine borate is used as the electrolytic solution.

PTL 2 proposes “an electrolytic solution for use in an electrolytic capacitor including an anode having a dielectric oxide film, a cathode, a separator disposed between the anode and the cathode, and a conductive polymer and an electrolytic solution held by the separator, the electrolytic solution including a first solvent containing lactone, . . . and a second solvent”. Used as the second solvent is “at least one of 1,3-propylene glycol, 1,4-butanediol, 1,5-pentanediol, 1,6-hexanediol, and derivatives thereof as well as 1,3-butanediol, 2-methyl-1,3-propanediol, 3-methyl-1,5-pentanediol, 2-methylpentane-2,4-diol, 2,4-diethyl-1,5-pentanediol, and derivatives thereof”. In examples, boric acid and phosphorous acid are used.

PTL 3 proposes “an electrolytic capacitor including an anode body having a dielectric layer, and a solid electrolyte layer, where the solid electrolyte layer contains a conductive polymer containing a polyanion, an anion, and a cation, where the anion is an anion corresponding to a phosphorus-containing oxo acid, and the cation is a nitrogen-containing cation”.

### CITATION LIST

### Patent Literature

PTL 1: Unexamined Japanese Patent Publication No. 2017-69390
PTL 2: Unexamined Japanese Patent Publication No. 2017-228738
PTL 3: Japanese Patent No. 6550595

### SUMMARY

An aspect of the present disclosure relates to an electrolytic capacitor. The electrolytic capacitor includes a capacitor element and a liquid component. The capacitor element includes an anode body including a dielectric layer on a surface of the anode body and a conductive polymer covering a part of the dielectric layer. The liquid component contains a solvent, an inorganic acid, and an organic oxy compound. The amount of the organic oxy compound per mol of the inorganic acid is more than 0.5 mol. The organic oxy compound includes at least one selected from the group consisting of:
(A) two first carbon atoms adjacent to each other, each of the two first carbon atoms being a first carbon atom,
(B) two second carbon atoms adjacent to each other, each of the two second carbon atoms being a second carbon atom,
(C) a first carbon atom and a second carbon atom adjacent to each other, and
(D) one or more second carbon atoms, each of the one or more second carbon atoms being a second carbon atom, where the first carbon atom is a carbon atom to which only one group selected from OH group or COOH group is bonded, and the second carbon atom is a carbon atom to which two or more groups selected from OH group or COOH group are bonded.

Another aspect of the present disclosure relates to a method for manufacturing the electrolytic capacitor. The method for manufacturing includes a step of preparing the liquid component by dissolving the inorganic acid salt and the organic oxy compound in the solvent.

According to the present disclosure, an increase in the equivalent series resistance (ESR) of the electrolytic capacitor is suppressed in a high-temperature reliability test.

### BRIEF DESCRIPTION OF THE DRAWINGS

FIG. 1 is a schematic sectional view illustrating an electrolytic capacitor according to one exemplary embodiment of the present disclosure.

FIG. 2 is a schematic view for explaining a configuration of the capacitor element in FIG. 1.

### DESCRIPTION OF EMBODIMENT

When an electrolytic capacitor including a conductive polymer is subjected to high temperature in a high-temperature reliability test, the conductivity of the conductive polymer decreases and the ESR increases.

An exemplary embodiment of the present disclosure will be described below with reference to examples, but the present disclosure is not limited to the examples described below. Although specific numerical values and materials may be provided as examples in the description below, other numerical values and materials may be used as long as the effect of the present disclosure can be obtained. In the present description, an expression “numerical value A to numerical value B” includes the numerical value A and the numerical value B, and can be read as “from numerical value A to numerical value B inclusive”. In the following description, when lower limits and upper limits of a numerical value related to a specific physical property, condition, or the like are presented as examples, any of the presented lower limits and any of the presented upper limits can be arbitrarily combined unless the lower limit is more than or equal to the upper limit. When a plurality of materials is presented as examples, one kind may be selected among the materials to be used solely, or two or more kinds may be used in combination.

Further, the present disclosure encompasses a combination of matters in two or more claims arbitrarily selected from a plurality of claims described in the appended claims. That is, as long as there is no technical contradiction, matters in two or more claims arbitrarily selected from a plurality of claims described in the appended claims can be combined.

“Electrolytic capacitor” may be read as “solid electrolytic capacitor” or “solid hybrid electrolytic capacitor”. “Conductive polymer” forms at least a part of a solid electrolyte layer.

An electrolytic capacitor according to one exemplary embodiment of the present disclosure (hereinafter, also referred to as “electrolytic capacitor (HV)”) includes a capacitor element and a liquid component. The capacitor element includes an anode body including a dielectric layer on a surface thereof and a conductive polymer covering a part of the dielectric layer.

Typically, the electrolytic capacitor is subjected to a reflow temperature after being mounted on a circuit member. In addition, the electrolytic capacitor is required to operate normally at high temperature resulting from heat generated by a ripple current. That is, the electrolytic capacitor is required to have high heat resistance.

In particular, when the electrolytic capacitor including a liquid component containing an inorganic acid is subjected to a high-temperature reliability test, the inorganic acid may decrease and the pH of the electrolytic solution may rise. As a result, dedoping of the conductive polymer is induced to reduce the conductivity of the conductive polymer, and ESR may increase. In particular, when the solvent of the liquid component contains a polyhydric alcohol, an esterification reaction between the solvent and the inorganic acid proceeds, which is likely to cause a decrease or elimination of acid components.

A liquid component included in electrolytic capacitor (HV) according to the present disclosure (hereinafter, also referred to as “liquid component (BA)”) includes a solvent, an inorganic acid, and an organic oxy compound. The organic oxy compound and the inorganic acid are dissolved in the solvent. The amount of the organic oxy compound per mol of the inorganic acid is more than 0.5 mol.

### (Liquid Component)

Liquid component (BA) contains a solvent, an inorganic acid, and an organic oxy compound having predetermined characteristics, and the amount of the organic oxy compound per mol of the inorganic acid is more than 0.5 mol. When the organic oxy compound having the predetermined characteristics is present by a sufficient amount with respect to the inorganic acid, an increase in the ESR of the electrolytic capacitor is significantly suppressed in a high-temperature reliability test. This is considered due to suppression of a rise in pH resulting from a decrease or elimination of the inorganic acid and suppression of dedoping of the conductive polymer.

Liquid component (BA) may further contain a base compound. The base compound has effects of improving stability of the inorganic acid in a high-temperature environment, suppressing volatilization of liquid component (BA) in high temperature, and enhancing restorability of the dielectric layer. The base compound may be a conjugate base of an inorganic acid salt.

### (a) Organic Oxy Compound

The organic oxy compound includes at least one of the following (A) to (D).
(A) Two first carbon atoms adjacent to each other
(B) Two second carbon atoms adjacent to each other
(C) A first carbon atom and a second carbon atom adjacent to each other
(D) One or more second carbon atoms

The first carbon atom is a carbon atom to which only one group selected from OH group or COOH group is bonded. The second carbon atom is a carbon atom to which two or more groups selected from OH group or COOH group are bonded.

In liquid component (BA) containing the organic oxy compound having the above characteristics (hereinafter, also referred to as “organic oxy compound (OH)”), when the amount of organic oxy compound (OH) per mol of the inorganic acid is more than 0.5 mol, a rise in pH is less likely to occur in a high-temperature reliability test. When organic oxy compound (OH) is present in a predetermined content proportion or more with respect to the inorganic acid, the first carbon atom and the second carbon atom satisfying the above (A) to (D) are considered to exhibit an effect of suppressing a rise in pH of liquid component (BA). First, it can be inferred that in liquid component (BA) containing organic oxy compound (OH), the progress of a decomposition reaction (for example, an esterification reaction) of the inorganic acid is suppressed. Secondly, it can be inferred that an OH group or a COOH group of organic oxy compound (OH) interacts with the inorganic acid to enhance the stability of both the inorganic acid and organic oxy compound (OH).

Organic oxy compound (OH) may be dissolved in a solvent in liquid component (BA), and may be a solid at 25° C. in an isolated state. However, from a viewpoint of reducing the viscosity of liquid component (BA), the molecular weight of organic oxy compound (OH) is preferably controlled to be in a range from 100 to 350, inclusive.

The first carbon atom may be a carbon atom constituting an aromatic ring. That is, organic oxy compound (OH) may be an organic aromatic compound having total of two or more of OH groups or COOH groups that directly bond to the aromatic ring. The molecular weight of such an organic aromatic compound may range, for example, from 125 to 350, inclusive. The aromatic ring may be a benzene ring, a heterocyclic ring, a monocyclic aromatic ring, or a polycyclic aromatic ring. Among them, an organic aromatic compound having a monocyclic aromatic ring is preferable from a viewpoint of reducing the viscosity of liquid component (BA). Examples of such organic oxy compounds (OH) include pyrogallol, pyrocatechol, salicylic acid, o-phthalic acid, 3,4-dihydroxybenzoic acid, 4-t-butylpyrocatechol, and gallic acid.

From a viewpoint of enhancing the interaction between organic oxy compound (OH) and the inorganic acid, the aromatic ring desirably does not have a bulky substituent, for example, there may be no alkyl group bonded to the aromatic ring. When a carboxyl group is bonded to the first carbon atom of organic oxy compound (OH), organic oxy compound (OH) may have only two first carbon atoms. Among the organic aromatic compounds having a monocyclic aromatic ring, pyrogallol, pyrocatechol, salicylic acid, and o-phthalic acid are preferable, for example.

The second carbon atom may be a carbon atom constituting a sugar compound. That is, organic oxy compound (OH) may be a compound included in the category of sugar compound. The sugar compound may be a polysaccharide, but is preferably a monosaccharide or a disaccharide from a viewpoint of reducing the viscosity of liquid component (BA). The molecular weight of such a sugar compound may range, for example, from 140 to 200, inclusive. The second carbon atom may have two or more OH groups or two or more COOH groups. From a viewpoint of facilitating the interaction with the inorganic acid, the second carbon atom preferably has one OH group and one COOH group.

The sugar compound may be aldose, ketose, or sugar alcohol. Examples of the sugar alcohol include tetritol, pentitol, hexitol, heptitol, and octitol. More specifically, mannitol, sorbitol, erythritol, and the like are preferable.

As described above, various compounds can be used as organic oxy compound (OH). However, in consideration of stability, heat resistance, and viscosity, for example, of liquid component (BA), organic oxy compound (OH) is preferably, for example, at least one kind selected from the group consisting of pyrogallol, pyrocatechol, salicylic acid, o-phthalic acid, 3,4-dihydroxybenzoic acid, 4-t-butylpyrocatechol, tartaric acid, quinic acid, and citric acid.

### (b) Inorganic Acid

It is expected that the inorganic acid has an effect of suppressing deterioration of the conductive polymer and an effect of enhancing restorability of the dielectric layer, for example. The inorganic acid is preferably an oxo acid exhibiting appropriate acidity. Such an oxo acid may be, for example, an oxo acid containing at least one element selected from the group consisting of phosphorus, boron, aluminum, and silicon. Among them, at least one of an oxo acid containing phosphorus or an oxo acid containing boric acid is preferable, and an oxo acid containing boron is particularly preferable. The inorganic acid may contain, for example, at least one of phosphoric acid or boric acid, or may contain boric acid.

The oxo acid needs not necessarily be present in a typical structure in liquid component (BA). For example, the oxo acid containing boron needs not exist in a form of boric acid of B(OH)₃ or in a form of an anion of H₂BO₃⁻, HBO₃²⁻, or BO₃³⁻. For example, when there are two or more (preferably three or more) B—O bonds for each boron atom, it may be determined that an oxo acid containing boron is present. Similarly, when there are two or more (preferably three or more) P—O bonds for each phosphorus atom, it may be determined that an oxo acid containing phosphorus is present.

The content of the inorganic acid in liquid component (BA) may be selected from 3% by mass to 12% by mass, inclusive, or may be selected from 3% by mass to 10% by mass, inclusive. However, the content of the inorganic acid is determined so that the amount of the organic oxy compound per mol of the inorganic acid is more than 0.5 mol. The amount of the organic oxy compound per mol of the inorganic acid may be more than or equal to 0.6 mol, more than or equal to 0.7 mol, more than or equal to 0.8 mol, or more than or equal to 1 mol. The amount of the organic oxy compound per mol of the inorganic acid may range from 0.6 mol to 5 mol, inclusive. Examples of preferable amount of the organic oxy compound per mol of the inorganic acid may range from 1 mol to 3 mol, inclusive, or from 1.1 mol to 2.5 mol, inclusive.

When the inorganic acid is an oxo acid containing at least one element (hereinafter, also referred to as “central element”) selected from the group consisting of phosphorus, boron, aluminum, and silicon, “per mol of inorganic acid” may be read as “per mol of central element”. That is, when the inorganic acid is an oxo acid containing boron, “per mol of inorganic acid (oxo acid containing boron)” may be read as “per mol of boron”. In addition, when the inorganic acid is an oxo acid containing phosphorus, “per mol of inorganic acid (oxo acid containing phosphorus)” may be read as “per mol of phosphorus”.

### (c) Solvent

The solvent is not limited to particular kinds. The solvent is typically liquid at 25° C. The solvent may be a protic solvent or an aprotic solvent. As the solvent, for example, a polyhydric alcohol, a lactone compound, a sulfone compound, or a carbonate compound can be used. Among them, at least one selected from the group consisting of a polyhydric alcohol, a lactone compound, and a sulfone compound is preferable. Preferably, the solvent is liquid still at 10° C.

The polyhydric alcohol has high restorability for dielectric layers. The polyhydric alcohol preferably has two or more hydroxy groups. The polyhydric alcohol improves the orientation of the conductive polymer, and thus is also preferable for enhancing the conductivity of the conductive polymer. The polyhydric alcohol may be a dihydric alcohol (for example, a glycol compound) or a trihydric alcohol (for example, a glycerin compound). The polyhydric alcohol may be an alcohol having no heteroatom other than oxygen atom (such as sulfur atom, boron atom, phosphorus atom, and nitrogen atom). The polyhydric alcohol may be an alcohol having no carbonyl group. The polyhydric alcohol may be a sugar compound other than organic oxy compound (OH).

The polyhydric alcohol preferably contains at least one selected from the group consisting of a glycol compound and a glycerin compound. In this case, the crystallizability of the conductive polymer is enhanced to readily improve conductivity. Examples of the glycol compound include ethylene glycol, propylene glycol, diethylene glycol, triethylene glycol, polyalkylene glycol (that is, polyethylene glycol having a molecular weight less than or equal to 2000), and polyoxyethylene polyoxypropylene glycol (ethylene oxide-propylene oxide copolymer). Examples of the glycerin compound include glycerin and polyglycerin. Preferable as the polyglycerin are diglycerin and triglycerin, for example. Among them, ethylene glycol is preferable, and ethylene glycol may account for 10 mass % or more of the solvent.

Examples of the sulfone compound include sulfolane, dimethyl sulfoxide, and diethyl sulfoxide. Among them, sulfolane is preferable, and a proportion of sulfolane in the solvent may be 10 mass % or more.

Examples of the lactone compounds include γ-butyrolactone and γ-valerolactone. Among them, γ-butyrolactone is preferable, and a proportion of γ-butyrolactone in the solvent may be 10 mass % or more.

Examples of the carbonate compound include dimethyl carbonate, diethyl carbonate, ethyl methyl carbonate, ethylene carbonate, propylene carbonate, and fluoroethylene carbonate.

The content of the solvent in liquid component (BA) is, for example, 30 mass % or more, may be 50 mass % or more, or is preferably 60 mass % or more. As a result, the viscosity of liquid component (BA) can be suppressed as low as possible. The content of the solvent in liquid component (BA) is, for example, less than or equal to 95 mass %, preferably less than or equal to 90 mass %, and may be less than or equal to 85 mass %, less than or equal to 80 mass %, less than or equal to 75 mass %, or less than or equal to 70 mass %. In this case, thermal degradation of the electrolytic capacitor under a high-temperature environment can be more effectively suppressed.

### (d) Base Compound

Liquid component (BA) may further contain a base compound. The base compound is not particularly limited, and for example, a primary amine, a secondary amine, a tertiary amine, a quaternary ammonium compound, and an amidinium compound may be used. As the base compound, at least one first base compound selected from the group consisting of an aliphatic amine, an alicyclic amine, an aromatic amine, a heterocyclic amine, and onium ions of these amines may be used. In this case, a proportion of the first base compound in the base compound may be 80 mass % or more or 100 mass %.

More specific examples of the base compound include methylamine, dimethylamine, trimethylamine, ethylamine, diethylamine, triethylamine, ethyldimethylamine, ethylenediamine, N,N-diisopropylethylamine, aniline, pyrrolidine, phenethylamine, toluidine, imidazole (1,2,3,4-tetramethylimidazolinium, 1,3-dimethyl-2-ethylimidazole, etc.), and 4-dimethylaminopyridine.

As the base compound, a salt of the base compound and the above-described inorganic acid (inorganic acid salt) may be used. In this case, the base compound may be derived only from the inorganic acid salt, and a part of the base compound may not be derived from the inorganic acid salt. As the base compound constituting the inorganic acid salt, the above-described amine may be used. For example, a salt of the first base compound and the inorganic acid described above may be used. The salt of the base compound and the inorganic acid described above (inorganic acid salt) may be a salt including the base compound, the inorganic acid, and an organic oxy compound (OH).

The inorganic acid salt may be, for example, an oxo acid salt containing boron, an oxo acid salt containing phosphorus. Specific examples of such an oxo acid salt include diethylamine borate and triethylamine borodisalicylate.

The amount of the base compound per mol of the inorganic acid may range from 0.8 mol to 1.2 mol, inclusive, from 0.9 mol to 1.1 mol, inclusive, or 1 mol. The content of the base compound in liquid component (BA) ranges, for example, from 10 parts by mass to 100 parts by mass, inclusive, or may range from 20 parts by mass to 80 parts by mass, inclusive, with respect to 100 parts by mass of the inorganic acid.

The pH of liquid component (BA) is preferably less than or equal to 4, more preferably less than or equal to 3.8, still more preferably less than or equal to 3.6. When the pH of liquid component (BA) is less than or equal to 4, degradation of the conductive polymer is further suppressed. The pH is preferably more than or equal to 2.

### (Electrolytic Capacitor)

Electrolytic capacitor (HV) includes a capacitor element and liquid component (BA). The capacitor element includes an anode body including a dielectric layer on a surface thereof and a conductive polymer covering a part of the dielectric layer. Electrolytic capacitor (HV) may include a bottomed case that houses the capacitor element, a sealing member that seals an opening of the bottomed case, and an external terminal that penetrates the sealing member.

### (Capacitor Element)

The capacitor element includes at least an anode body that has a dielectric layer on a surface thereof, and a conductive polymer component that covers a part of the dielectric layer.

The capacitor element may include a wound body. The wound body may include an anode body, a cathode body, and a separator disposed therebetween. The separator may be, for example, a known separator used in electrolytic capacitors. The conductive polymer not only covers at least a part of the dielectric layer on a surface of the anode body but may also adhere to the separator and the cathode body.

### (Anode Body)

The anode body may include a valve metal, an alloy containing a valve metal, and a compound containing a valve metal. These materials can be used solely or in combination of two or more types of the materials. As the valve metal, for example, aluminum, tantalum, niobium, and titanium are preferably used. The anode body of which surface is porous can be obtained, for example, by roughening a surface of a base material (such as a foil-shaped or plate-shaped base material) containing a valve metal by etching, for example. Furthermore, the anode body may be a compact of particles that contain a valve metal or a sintered body of such a compact. Note that the sintered body has a porous structure.

### (Dielectric Layer)

The dielectric layer is formed by anodizing the valve metal on a surface of the anode body by an anodizing treatment or the like. The dielectric layer is formed so as to cover at least a part of the anode body. The dielectric layer is typically formed on a surface of the anode body. Since the dielectric layer is formed on a porous surface of the anode body, the dielectric layer is formed along inner wall surfaces of holes and hollows (pits) on the surface of the anode body.

The dielectric layer contains an oxide of a valve metal. For example, when tantalum is used as a valve metal, the dielectric layer contains Ta₂O₅, and when aluminum is used as a valve metal, the dielectric layer contains Al₂O₃. The dielectric layer is not limited to those described above, and any dielectric layer may be used as long as the dielectric layer functions as a dielectric body. When the anode body has a porous surface, the dielectric layer is formed along the surface of the anode body (including inner wall surfaces of holes).

### (Conductive Polymer)

The conductive polymer includes, for example, a conductive polymer and a dopant. The conductive polymer is attached so as to cover a part of the dielectric layer. The conductive polymer attached to a surface of the dielectric layer may constitute a conductive polymer layer. The conductive polymer layer may also be referred to as a solid electrolyte layer. The conductive polymer constitutes at least a part of a cathode body of the electrolytic capacitor.

Examples of the conductive polymer include a π-conjugated polymer. Examples of the conductive polymer include polypyrrole, polythiophene, polyfuran, polyaniline, polyacetylene, polyphenylene, polyphenylene vinylene, polyacene, and polythiophene vinylene. These may be used solely or in combination of two or more types thereof or may be a copolymer of two or more types of monomers.

Note that, in the present specification, polypyrrole, polythiophene, polyfuran, and polyaniline, for example, mean polymers having, as a basic skeleton, polypyrrole, polythiophene, polyfuran, and polyaniline, respectively. Thus, polypyrrole, polythiophene, polyfuran, polyaniline, and the like each can also include its derivative. For example, polythiophene includes poly(3,4-ethylenedioxythiophene) and the like.

The dopant can be selected depending on the π-conjugated polymer, and a known dopant may be used. Examples of dopants include a compound that can provide an anion (for example, aromatic sulfonic acid (such as naphthalenesulfonic acid and p-toluenesulfonic acid) and a salt thereof), a polyanion (for example, polymer-type polyanions (such as polystyrene sulfonic acid)). Examples of the solid electrolyte include polypyrrole doped with aromatic sulfonic acid and poly(3,4-ethylenedioxythiophene) (PEDOT) doped with polystyrene sulfonic acid (PSS).

The conductive polymer layer can be formed, for example, by chemically or electrolytically polymerizing a raw material monomer on the dielectric layer. Alternatively, the conductive polymer layer can be formed by bringing into contact with the dielectric layer a solution in which the conductive polymer is dissolved or a dispersion liquid in which the conductive polymer is dispersed. The conductive polymer layer may be formed to cover at least a part of the dielectric layer.

A metal foil may be used for the cathode body as is used for the anode body. The type of the metal is not particularly limited, but it is preferable to use a valve metal such as aluminum, tantalum, or niobium or an alloy containing the valve metal. A surface of the metal foil may be roughened as necessary. On the surface of the metal foil, an anodization film may be provided, and the film may be of a metal different from the metal constituting the metal foil (dissimilar metal) or may be a nonmetal. Examples of the different type of metal and the nonmetal include metals such as titanium and nonmetals such as carbon.

### (Separator)

When the metal foil is used for the cathode body, a separator may be disposed between the metal foil and the anode body. There is no particular limitation on the separator. For example, a nonwoven fabric including a fiber of cellulose, polyethylene terephthalate, vinylon, or polyamide (for example, aliphatic polyamide or aromatic polyamide such as aramid) may be used.

Hereinafter, the electrolytic capacitor of the present disclosure will be described more specifically based on an exemplary embodiment. However, the electrolytic capacitor of the present disclosure is not limited to the following exemplary embodiment.

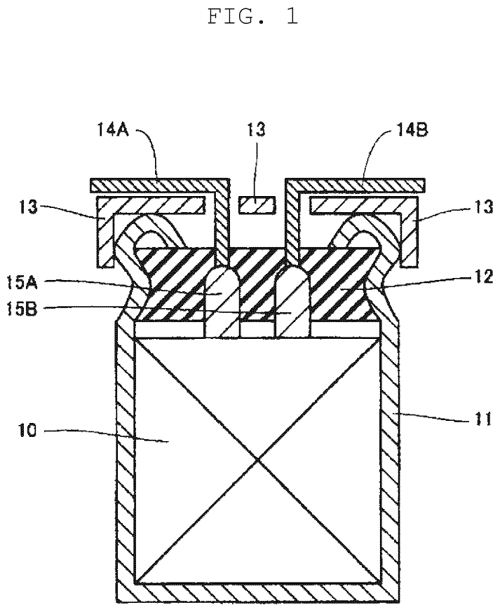

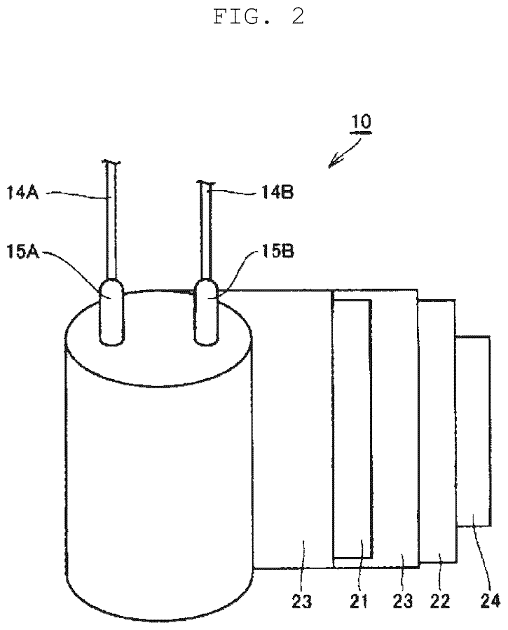

FIG. 1 is a schematic sectional view illustrating an electrolytic capacitor according to the present exemplary embodiment, and FIG. 2 is a partially developed schematic view illustrating a capacitor element of the electrolytic capacitor.

An electrolytic capacitor illustrated in FIG. 1 includes capacitor element 10, bottomed case 11 that houses capacitor element 10, sealing member 12 that closes an opening of bottomed case 11, base plate 13 that covers sealing member 12, lead wires 14A, 14B that are led out from sealing member 12 and penetrate base plate 13, lead tabs 15A, 15B that connect the lead wires to electrodes of capacitor element 10, and a liquid component (not illustrated). An opening end of bottomed case 11 is curled so as to be caulked to sealing member 12.

Capacitor element 10 is manufactured from a wound body as illustrated in FIG. 2. The wound body is a semi-finished product of capacitor element 10, and refers to a product in which a conductive polymer is not disposed between anode body 21 having a dielectric layer on a surface thereof and cathode body 22. The wound body is formed by winding anode body 21 connected to lead tab 15A and cathode body 22 connected to lead tab 15B with separator 23 interposed therebetween. The outermost periphery of the wound body is fixed by fastening tape 24. Note that FIG. 2 illustrates a state in which a part of the wound body of which outermost periphery is not yet fixed is developed.

Anode body 21 includes a metal foil of which surface is roughened, and a dielectric layer is formed on the roughened surface. Capacitor element 10 is formed by attaching the conductive polymer to at least a part of the surface of the dielectric layer. Capacitor element 10 is housed in an outer case together with liquid component (BA) (not illustrated).

Although the wound-type electrolytic capacitor is illustrated here, the electrolytic capacitor may be of a chip type or a laminated type. The capacitor element may have a configuration selected depending on the type of the electrolytic capacitor.

The electrolytic capacitor may include at least one capacitor element, or a plurality of capacitor elements. The number of capacitor elements included in the electrolytic capacitor may be determined in accordance with application.

Hereinafter, an example of a method for manufacturing an electrolytic capacitor will be described.

### (i) Step of Preparing Cathode Body 22 and Anode Body 21 Including a Dielectric Layer

As raw materials of anode body 21 and cathode body 22, a metal foil formed of a valve metal is used. In a case of anode body 21, a surface of the metal foil is roughened by an etching treatment or the like, and a plurality of irregularities are formed on the surface of the metal foil. Next, a dielectric layer is formed on the roughened surface of the metal foil by an anodizing treatment or the like. If necessary, the surface of cathode body 22 may be roughened.

### (ii) Manufacturing of Wound Body

Anode body 21 and cathode body 22 are wound with separator 23 interposed therebetween to manufacture a wound body. As separator 23, a nonwoven fabric containing synthetic cellulose, for example, as a main component can be used. Fastening tape 24 is put on the outer surface of cathode body 22 at an outermost layer of the wound body to fix an end of cathode body 22. As necessary, an anodizing treatment is further performed on the wound body.

(iii) Step of Forming Capacitor Element 10

For example, a liquid polymer dispersion is impregnated in the dielectric layer so that a conductive polymer film is formed to cover at least a part of the dielectric layer. Consequently, capacitor element 10 in which the conductive polymer is disposed between anode body 21 and cathode body 22 is obtained. The step of applying the polymer dispersion on the surface of the dielectric layer may be repeated two or more times. Capacitor element 10 is then impregnated with liquid component (BA). As a result, an electrolytic capacitor including the conductive polymer and liquid component (BA) can be obtained.

Liquid component (BA) may be prepared by dissolving the inorganic acid salt and the organic oxy compound in a solvent. That is, a salt formed from a base compound may be used as the inorganic acid. In this case, the inorganic acid is derived from the inorganic acid salt. As the base compound, an amine described above may be used. For example, at least one first base compound selected from the group consisting of an aliphatic amine, a alicyclic amine, an aromatic amine, and a heterocyclic amine may be used.

### (iv) Step of Sealing Capacitor Element

Capacitor element 10 is housed in bottomed case 11 with liquid component (BA) such that lead wires 14A, 14B are located on an opening side of bottomed case 11. Next, the opening of bottomed case 11 is closed by sealing member 12 which the lead wires penetrate, an end of the opening of bottomed case 11 is caulked to sealing member 12 to be curled, and base plate 13 is disposed on the curled part, whereby the electrolytic capacitor illustrated in FIG. 1 is completed.

In the above exemplary embodiment, the wound-type electrolytic capacitor has been described, but the range of application of the present invention is not limited to the above exemplary embodiment. The present invention can also be applied to other electrolytic capacitors, for example, a chip-type electrolytic capacitor using a metal sintered body as an anode body, or a stacked-type electrolytic capacitor using a metal plate as an anode body.

### Supplementary Note

The following techniques are disclosed by the above description.

### Technique 1

An electrolytic capacitor including
a capacitor element, and
a liquid component, wherein:
the capacitor element includes an anode body including a dielectric layer on a surface of the anode body, and a conductive polymer covering a part of the dielectric layer,
the liquid component contains a solvent, an inorganic acid, and an organic oxy compound,
an amount of the organic oxy compound per mol of the inorganic acid is more than 0.5 mol,
the organic oxy compound includes at least one selected from the group consisting of:
(A) two first carbon atoms adjacent to each other, each of the two first carbon atoms being a first carbon atom,
(B) two second carbon atoms adjacent to each other, each of the two second carbon atoms being a second carbon atom,
(C) a first carbon atom and a second carbon atom adjacent to each other, and
(D) one or more second carbon atoms, each of the one or more second carbon atoms being a second carbon atom,
where the first carbon atom is a carbon atom to which only one group selected from OH group or COOH group is bonded, and the second carbon atom is a carbon atom to which two or more groups selected from OH group or COOH group are bonded.

### Technique 2

The electrolytic capacitor according to Technique 1, wherein the first carbon atom is a carbon atom constituting an aromatic ring.

### Technique 3

The electrolytic capacitor according to Technique 1 or 2, wherein the second carbon atom is a carbon atom constituting a sugar compound.

### Technique 4

The electrolytic capacitor according to any one of Techniques 1 to 3, wherein the second carbon atom has one OH group and one COOH group.

### Technique 5

The electrolytic capacitor according to any one of Techniques 1 to 4, wherein the organic oxy compound is at least one selected from the group consisting of pyrogallol, pyrocatechol, salicylic acid, o-phthalic acid, 3,4-dihydroxybenzoic acid, 4-t-butylpyrocatechol, gallic acid, tartaric acid, quinic acid, and citric acid.

### Technique 6

The electrolytic capacitor according to any one of Techniques 1 to 5, wherein the inorganic acid is an oxo acid containing at least one element selected from the group consisting of phosphorus, boron, aluminum, and silicon.

### Technique 7

The electrolytic capacitor according to any one of Techniques 1 to 6, wherein the inorganic acid is at least one of an oxo acid containing phosphorus or an oxo acid containing boron.

### Technique 8

The electrolytic capacitor according to any one of Techniques 1 to 7, wherein an amount of the organic oxy compound per mol of the inorganic acid ranges from 0.6 mol to 5 mol, inclusive.

### Technique 9

The electrolytic capacitor according to any one of Techniques 1 to 8, wherein the liquid component further includes a base compound.

### Technique 10

The electrolytic capacitor according to Technique 9, wherein the base compound contains at least one first base compound selected from the group consisting of an aliphatic amine, an alicyclic amine, an aromatic amine, a heterocyclic amines, an onium ion of the aliphatic amine, an onium ion of the alicyclic amine, an onium ion of the aromatic amine, and an onium ion of the heterocyclic amine.

### Technique 11

The electrolytic capacitor according to Technique 9 or 10, wherein an amount of the base compound per mol of the inorganic acid ranges from 0.5 mol to 1.0 mol, inclusive.

### Technique 12

The electrolytic capacitor according to any one of Techniques 1 to 11, wherein the solvent contains at least one selected from the group consisting of a polyhydric alcohol, a lactone compound and a sulfone compound.

### Technique 13

The electrolytic capacitor according to any one of Techniques 1 to 12, wherein a content of the inorganic acid in the liquid component ranges from 3% by mass to 12% by mass, inclusive.

### Technique 14

A method for manufacturing the electrolytic capacitor according to any one of Techniques 1 to 13,
the method comprising a step of preparing the liquid component by dissolving the inorganic acid salt and the organic oxy compound in the solvent.

### Technique 15

The method according to Technique 14, wherein:
the inorganic acid forms a salt with a base compound, and
the base compound contains at least one first base compound selected from the group consisting of an aliphatic amine, an alicyclic amine, an aromatic amine, and a heterocyclic amine.

### EXAMPLES

Hereinafter, the present invention is specifically described with reference to examples and comparative examples, but the present invention is not limited to the following examples.

### <<Electrolytic Capacitors A1 to A9 and B1 to B4>>

Wound-type electrolytic capacitors (Φ (diameter) 10 mm×L (length) 10 mm) having a rated voltage of 25 V and a rated capacitance of 330 μF were manufactured. A specific method for manufacturing the electrolytic capacitor will be described below.

### (Preparation of Anode Body)

An aluminum foil having a thickness of 100 μm was subjected to an etching treatment to roughen a surface of the aluminum foil. Then, a dielectric layer was formed on the surface of the aluminum foil by an anodizing treatment. The anodizing treatment was performed by immersing the aluminum foil in an ammonium adipate solution, followed by application of a voltage. Then, the aluminum foil was cut, whereby an anode body was prepared.

### (Preparation of Cathode Body)

An aluminum foil having a thickness of 50 μm was subjected to an etching treatment to roughen a surface of the aluminum foil. Then, the aluminum foil was cut, whereby a cathode body was prepared.

### (Manufacturing of Wound Body)

An anode lead tab and a cathode lead tab were connected to the anode body and the cathode body, respectively, and the anode body and the cathode body were wound with a separator interposed between the anode body and the cathode body and with the lead tabs being wound. An anode lead wire and a cathode lead wire were connected to ends of the lead tabs protruding from the wound body, respectively. The manufactured wound body was subjected to an anodizing treatment again to form a dielectric layer on a cutting end of the anode body. Next, an end of the outer surface of the wound body was fixed with a fastening tape, whereby the wound body was manufactured.

### (Preparation of Polymer Dispersion)

A mixed solution was prepared by dissolving, in ion-exchanged water, 3,4-ethylenedioxythiophene and polystyrene sulfonic acid (PSS, weight average molecular weight: 100000) which is a polymer dopant. While the mixed solution was being stirred, iron (III) sulfate (oxidant) dissolved in ion-exchanged water was added to perform a polymerization reaction. After the reaction, the obtained reaction solution was dialyzed to remove unreacted monomers and excess oxidants, whereby a polymer dispersion containing polyethylene dioxythiophene doped with about 5 mass % of PSS (PEDOT/PSS) was obtained.

### (Formation of Solid Electrolyte Layer)

The wound body was immersed for 5 minutes in a decompressed atmosphere (40 kPa) in the polymer dispersion stored in a predetermined container, and then the wound body was pulled out from the polymer dispersion. Next, the wound body impregnated with the polymer dispersion was dried in a drying furnace at 150° C. for 20 minutes to form a solid electrolyte layer including a conductive polymer layer and covering at least a part of the dielectric layer. A capacitor element was thus formed.

### (Preparation of Liquid Component)

Liquid component (BA) containing a solvent, an inorganic acid, a base compound, and an organic oxy compound (OH) was prepared. Ethylene glycol (EG) was used as a solvent. Diethylamine borate (BADEA) which is a salt of an inorganic acid and a base compound was dissolved at a content of 3% by mass or triethylamine borodisalicylate (BSTEA) was dissolved at a content of 8% by mass. Further, 2 mol of organic oxy compound (OH) shown in Table 1 or an additive similar thereto was dissolved per mol of boron. The additive was not dissolved in the liquid component for electrolytic capacitors B1, B2.

### (Assembling of Electrolytic Capacitor)

The wound body in which the solid electrolyte layer was formed was immersed in the liquid component in a decompressed atmosphere (40 kPa) for 5 minutes. As a result, a capacitor element impregnated with the liquid component was obtained. The obtained capacitor element was sealed to complete an electrolytic capacitor as illustrated in FIG. 1. Thereafter, an aging treatment was performed at 130° C. for 2 hours while applying a rated voltage.

### [Evaluation]

### (Reflow Resistance (ESR1))

After heating the electrolytic capacitor according to a predetermined reflow profile (maximum temperature of 255° C., 10 seconds), the ESR (ESR1) of the electrolytic capacitor at a frequency of 100 kHz was measured in an environment of 20° C. using an LCR meter for 4-terminal measurement. The results are shown in Table 1.

### (High Temperature Reliability (ESR2))

A rated voltage (25 V) was applied to the electrolytic capacitor for 1000 hours at 145° C. Thereafter, the ESR (ESR2) of the electrolytic capacitor was measured in an environment of 20° C. The results are shown in Table 1.

TABLE 1

| | | | | Evaluation | |
|---|---|---|---|---|---|
| | Inorganic acid salt | | Organic oxy compound | ESR1 | ESR2 |
| | BADEA | BSTEA | (OH), additive agent | (mΩ) | (mΩ) |
| B1 | | 8.0 | — | 11.6 | 27.8 |
| B2 | 3.0 | | — | 14.7 | 43.3 |
| B3 | 3.0 | | p-hydroxybenzoic acid | 12.4 | 51.2 |
| B4 | 3.0 | | Hydroxybenzoic acid | 12.5 | 43.3 |
| A1 | 3.0 | | Pyrogallol | 12.0 | 14.8 |
| A2 | 3.0 | | Pyrocatechol | 12.0 | 15.6 |
| A3 | 3.0 | | 3,4-dihydroxybenzoic acid | 11.4 | 22.4 |
| A4 | 3.0 | | 4-t-butylpyrocatechol | 13.1 | 20.7 |
| A5 | 3.0 | | Salicylic acid | 10.7 | 14.8 |
| A6 | 3.0 | | o-phthalic acid | 11.3 | 13.9 |
| A7 | 3.0 | | Tartaric acid | 11.0 | 16.7 |
| A8 | 3.0 | | Quinic acid | 11.0 | 13.1 |
| A9 | 3.0 | | Citric acid | 11.0 | 14.0 |

The liquid components of electrolytic capacitors A1 to A6 contain organic aromatic compound (OH) having a monocyclic aromatic ring having total of two or more first carbon atoms. Organic oxy compounds (OH) of electrolytic capacitors A1 to A6 each have two first carbon atoms (A) adjacent to each other. Electrolytic capacitors A1 to A6 have small ESR1s and small ESR2s, and have good heat resistance. Further, when an alkyl group is not bonded to an aromatic ring of organic oxy compound (OH), even better heat resistance was obtained. It is found that when a carboxyl group is bonded to the first carbon atom of organic oxy compound (OH), having only two first carbon atoms can be superior to having total of three first carbon atoms in terms of heat resistance.

The liquid components of electrolytic capacitors A7 to A9 contain organic aromatic compound (OH) of a sugar compound having a second carbon atom. Organic oxy compounds (OH) of electrolytic capacitors A7 to A9 each have a second carbon atom to which one OH group and one COOH group are bonded. Electrolytic capacitors A7 to A9 have small ESR1s and small ESR2s, and have good heat resistance.

Meanwhile, electrolytic capacitors B3, B4 which are organic aromatic compounds each having a monocyclic aromatic ring having two first carbon atoms do not have two first carbon atoms (A) that are adjacent to each other, and are thus inferior, in terms of heat resistance, to electrolytic capacitors A1 to A6. Electrolytic capacitors B1, B2 are also inferior, in terms of heat resistance, to electrolytic capacitors A1 to A9 in which the liquid component contains organic aromatic compound (OH).

### <<Electrolytic Capacitors A10 to A21 and B5 to B7>>

In preparation of the liquid component, diethylamine borate (BADEA) or diethylamine phosphate (PADEA) was dissolved in a solvent at a content ratio shown in Table 2, and organic oxy compound (OH) was also dissolved by a molar number shown in Table 2 per mol of boron or phosphorus. No additive was dissolved in the liquid component of electrolytic capacitor B7. The rest was similar to that of the examples described above, and the electrolytic capacitors were manufactured and evaluated. The results are shown in Table 2.

TABLE 2

| | | | Organic oxy compound | | | |
|---|---|---|---|---|---|---|
| | | | (OH) (molar number with | | Characteristics | |
| | Inorganic acid salt | | respect to B, P) | | ESR1 | ESR2 |
| | BADEA | PADEA | Pyrogallol | Pyrocatechol | (mΩ) | (mΩ) |
| B5 | 6.0 | | 0.5 | | 14.2 | 78.2 |
| A10 | 6.0 | | 1.0 | | 13.0 | 20.3 |
| A11 | 6.0 | | 2.0 | | 11.6 | 13.6 |
| A12 | 6.0 | | 3.0 | | 11.1 | 12.4 |
| A13 | 9.0 | | 2.0 | | 11.3 | 12.8 |
| A14 | 12.0 | | 2.0 | | 11.3 | 12.7 |
| B6 | 6.0 | | | 0.5 | 11.6 | 100.4 |
| A15 | 6.0 | | | 1.0 | 11.5 | 26.4 |
| A16 | 6.0 | | | 2.0 | 13.4 | 14.5 |
| A17 | 6.0 | | | 3.0 | 11.4 | 12.7 |
| A18 | 9.0 | | | 2.0 | 11.8 | 13.8 |
| A19 | 12.0 | | | 2.0 | 11.7 | 13.1 |
| B7 | | 6.0 | | | 15.2 | 90.2 |
| A20 | | 6.0 | 2.0 | | 14.5 | 17.2 |
| A21 | | 6.0 | | 2.0 | 14.7 | 18.0 |

It can be understood from Table 2 that high heat resistance cannot be obtained when the amount of organic oxy compound (OH) per mol of the inorganic acid is 0.5 mol, and that a larger amount (0.6 mol or more, or 1 mol or more) of organic oxy compound (OH) is necessary.

Although the present invention has been described for the preferred exemplary embodiment at present, such disclosure should not be construed in a way of limitation. Various variations and modifications will surely become apparent to those skilled in the art belonging to the technical field pertaining to the present invention by reading the above disclosure. Thus, the appended claims should be construed to include all modifications and alterations without departing from the true spirit and scope of the present invention.

### INDUSTRIAL APPLICABILITY

An electrolytic capacitor of the present disclosure can be used as a hybrid electrolytic capacitor that includes a solid electrolyte layer having a conductive polymer, and a liquid component or an electrolytic solution. The electrolytic capacitor is particularly suitable for applications requiring high heat resistance. However, the application of the electrolytic capacitor is not limited thereto.

### REFERENCE MARKS IN THE DRAWINGS

10 capacitor element
11 bottomed case
12 sealing member
13 base plate
14A, 14B lead wire
15A, 15B lead tab
21 anode body
22 cathode body
23 separator
24 fastening tape

1. An electrolytic capacitor comprising:
a capacitor element; and
a liquid component, wherein:
the capacitor element includes:
an anode body including a dielectric layer on a surface of the anode body, and
a conductive polymer covering a part of the dielectric layer,
the liquid component contains a solvent, an inorganic acid, and an organic oxy compound,
an amount of the organic oxy compound per mol of the inorganic acid is more than 0.5 mol,
the organic oxy compound includes at least one molecular structure selected from the group consisting of:
(A) two first carbon atoms adjacent to each other, each of the two first carbon atoms being a first carbon atom,
(B) two second carbon atoms adjacent to each other, each of the two second carbon atoms being a second carbon atom,
(C) a first carbon atom and a second carbon atom adjacent to each other, and
(D) one or more second carbon atoms, each of the one or more second carbon atoms being a second carbon atom,
where the first carbon atom is a carbon atom to which only one group selected from OH group or COOH group is bonded, and the second carbon atom is a carbon atom to which two or more groups selected from OH group or COOH group are bonded.

2. The electrolytic capacitor according to claim 1, wherein the first carbon atom is a carbon atom constituting an aromatic ring.

3. The electrolytic capacitor according to claim 1, wherein the second carbon atom is a carbon atom constituting a sugar compound.

4. The electrolytic capacitor according to claim 1, wherein the second carbon atom has one OH group and one COOH group.

5. The electrolytic capacitor according to claim 1, wherein the organic oxy compound is at least one selected from the group consisting of pyrogallol, pyrocatechol, salicylic acid, o-phthalic acid, 3,4-dihydroxybenzoic acid, 4-t-butylpyrocatechol, gallic acid, tartaric acid, quinic acid, and citric acid.

6. The electrolytic capacitor according to claim 1, wherein the inorganic acid is an oxo acid containing at least one element selected from the group consisting of phosphorus, boron, aluminum, and silicon.

7. The electrolytic capacitor according to claim 1, wherein the inorganic acid is at least one of an oxo acid containing phosphorus or an oxo acid containing boron.

8. The electrolytic capacitor according to claim 1, wherein an amount of the organic oxy compound per mol of the inorganic acid ranges from 0.6 mol to 5 mol, inclusive.

9. The electrolytic capacitor according to claim 1, wherein the liquid component further includes a base compound.

10. The electrolytic capacitor according to claim 9, wherein the base compound contains at least one first base compound selected from the group consisting of an aliphatic amine, an alicyclic amine, an aromatic amine, a heterocyclic amine, an onium ion of the aliphatic amine, an onium ion of the alicyclic amine, an onium ion of the aromatic amine, and an onium ion of the heterocyclic amine.

11. The electrolytic capacitor according to claim 9, wherein an amount of the base compound per mol of the inorganic acid ranges from 0.5 mol to 1.0 mol, inclusive.

12. The electrolytic capacitor according to claim 1, wherein the solvent contains at least one selected from the group consisting of a polyhydric alcohol, a lactone compound and a sulfone compound.

13. The electrolytic capacitor according to claim 1, wherein a content of the inorganic acid in the liquid component ranges from 3% by mass to 12% by mass, inclusive.

14. A method for manufacturing the electrolytic capacitor according to claim 1, the method comprising a step of preparing the liquid component by dissolving the inorganic acid salt and the organic oxy compound in the solvent.

15. The method according to claim 14, wherein:
the inorganic acid forms a salt with a base compound, and
the base compound contains at least one first base compound selected from the group consisting of an aliphatic amine, an alicyclic amine, an aromatic amine, and a heterocyclic amine.
